(19) United States
(12) Patent Application Publication
(10) Pub. No.: US 2024/0201052 A1
(43) Pub. Date: Jun. 20, 2024

(54) System And Method For Rapidly Collecting Greenhouse Gas From Farmland In Batches

(71) Applicant: Zhejiang University, Hangzhou (CN)

(72) Inventors: Qianjing JIANG, Hangzhou (CN); Guofeng YANG, Hangzhou (CN); Yong HE, Hangzhou (CN)

(21) Appl. No.: 18/497,122

(22) Filed: Oct. 30, 2023

(30) Foreign Application Priority Data
Dec. 19, 2022 (CN) 202211630340.3

(51) Int. Cl. G01N 1/22

(52) U.S. Cl. CPC G01N 1/22; G01N 2001/2297

(57) ABSTRACT

Disclosed are a system and method for rapidly collecting greenhouse gas from farmland in batches, relating to the technical field of greenhouse gas collection. The system for rapidly collecting greenhouse gas from farmland in batches includes a static chamber, a static chamber placement device, a gas collection device, and a control device. The static chamber is arranged inside the static chamber placement device, and each static chamber is sleeved outside crops. The gas collection device is arranged in the static chamber placement device. The static chamber, the static chamber placement device and the gas collection device are all in wireless connection with the control device.

### CROSS-REFERENCE TO RELATED APPLICATION

This patent application claims the benefit and priority of Chinese Patent Application No. 202211630340.3, filed with the China National Intellectual Property Administration on Dec. 19, 2022, the disclosure of which is incorporated by reference herein in its entirety as part of the present application.

### TECHNICAL FIELD

The present disclosure relates to the technical field of greenhouse gas collection, and in particular to a system and method for rapidly collecting greenhouse gas from farmland in batches.

### BACKGROUND

It is a major problem for the whole world to control greenhouse gas emissions and deal with climate change. As farmland ecosystem is an important source of greenhouse gas emissions, different crops as well as different agricultural management practices both have an impact on greenhouse gas emissions from farmland. Therefore, the effective collection of greenhouse gas from farmland is the basis and premise of accurately measuring greenhouse gas emissions from farmland.

At present, the collection method of greenhouse gas from farmland is mainly manual collection static chamber method. The conventional static chamber is generally composed of a chamber body and a base. The base is relatively fixed and heavy, and the static box is large, so it is not easy to place the static box to the corresponding base manually in the middle and late stages of crop growth, and the risk of overwhelming crops or damaging crops by external forces exists. The manual placement and retrieval of static chambers are cumbersome, with heavy workload, long time consumption and low overall efficiency. Artificial gas extraction is greatly affected by farmland environment, especially in paddy fields, where there are difficulties such as difficulty for people to walk, resulting in low efficiency of gas extraction.

### SUMMARY

In order to solve the problem above, a system and method for rapidly collecting greenhouse gas from farmland in batches are provided.

In order to achieve the above objective, the present disclosure provides the following solution: a system for rapidly collecting greenhouse gas from farmland in batches includes a static chamber, a static chamber placement device, a gas collection device, and a control device.

The static chamber is arranged inside the static chamber placement device, and each static chamber is sleeved outside crops. The gas collection device is arranged in the static chamber placement device, the static chamber, the static chamber placement device and the gas collection device are all in wireless connection with the control device.

Preferably, the static chamber includes a chamber body, a base, a thermometer, a fan, a liquid sealing device, an upright rubber tube, and a display screen.

The chamber body is buckled on the base. The thermometer and the fan are arranged inside the chamber body. The thermometer and the fan are both in wireless connection with the control device. The chamber body is provided with an extraction hole. The upright rubber tube is arranged at a position corresponding to the extraction hole. The liquid sealing device is arranged at an interface of the upright rubber tube. The chamber body is provided with four hooks, so as to be mounted by the static chamber placement device. The display screen is arranged on the chamber body, and the display screen is in wireless connection with the control device.

Preferably, the static chamber placement device includes multiple fixing posts, a motor assembly, and a traction device.

A space frame is formed by the multiple fixing posts. The traction device is arranged at a top end of the space frame, the motor assembly is arranged on the traction device, and the traction device is used for mounting the gas collection device or the static chamber. The motor assembly is in wireless connection with the control device.

Preferably, the gas collection device includes a camera device, a vacuum gas pump, a gas inlet pipe, a gas bag box, an exhaust pipe, and a gas chamber.

The camera device is arranged on the gas chamber. The gas inlet pipe passes through the gas chamber and then extends into the gas bag box. The vacuum gas pump is arranged inside the gas chamber. One end of the exhaust pipe is inserted into the gas chamber, and both the exhaust pipe and the gas inlet pipe are connected to the vacuum gas pump.

Preferably, the control device includes an Internet of Things processor and a control apparatus.

The Internet of Things processor is used for generating control data of an electrical signal in the static chamber.

The control apparatus is used for generating control data of an electrical signal in the static chamber placement device.

According to specific embodiments provided by the present disclosure, the present disclosure discloses the following technical effects:

The system for rapidly collecting greenhouse gas from farmland in batches includes a static chamber, a static chamber placement device, a gas collection device, and a control device. The static chamber is arranged inside the static chamber placement device, and each static chamber is sleeved outside crops. The gas collection device is arranged in the static chamber placement device. The static chamber, the static chamber placement device and the gas collection device are all in wireless connection with the control device. As can be seen from the present disclosure, automatic collection of the greenhouse gases from the farmland can be achieved using the static chamber, the static chamber placement device, the gas collection device and the control device, thereby satisfying the requirements of collecting the greenhouse gases from the farmland rapidly and conveniently under different farmland environments.

In addition, the present disclosure also provides a method for rapidly collecting greenhouse gas from farmland in batches. The method includes the following steps: obtaining a gas collection task load; determining a task duration based on the gas collection task load; determining operating parameters of components in a system for rapidly collecting greenhouse gas from farmland in batches based on the task duration, where the system for rapidly collecting greenhouse gas from farmland in batches is the system according to any one of claims 1-5, and the operating parameters comprise: placement speed of a static chamber placement device and an injection flow rate of a vacuum gas pump; and respectively determining the total time of a static chamber placement stage and the total time of a gas collection stage based on the operating parameters.

Preferably, determining the total time of the static chamber placement stage based on the operating parameters includes the following steps: determining a placement path of a static chamber according to a placement position of the static chamber and a lifting distance of the placed static chamber; setting placement time based on the placement path and placement speed of the static chamber; and determining the total time of the static chamber placement stage based on the placement time.

Preferably, determining the total time of the gas collection stage based on the operating parameters includes the following steps: determining an air tightness leakage rate of a gas chamber; determining evacuation time of the gas chamber based on the air tightness leakage rate; determining extraction time of the gas chamber of a single static chamber and gas injection time of a single gas bag; and determining the total time of the gas collection stage according to the evacuation time, the extraction time and the gas injection time.

The method for rapidly connecting greenhouse gas from farmland in batches provided by the present disclosure is used to assist the system for rapidly connecting greenhouse gas from farmland in batches to achieve the above technical effects, and thus will not be described in detail here.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and those of ordinary skill in the art may still derive other drawings from these accompanying drawings without creative efforts.

FIG. 1 is a structural schematic diagram of a system for rapidly collecting greenhouse gas from farmland in batches in accordance with the present disclosure;

FIG. 2 is a schematic diagram of a liquid sealing device in a static chamber in accordance with an embodiment of the present disclosure;

FIG. 3 is a schematic diagram of a static chamber placement device in accordance with an embodiment of the present disclosure;

FIG. 4 is a schematic diagram of a gas collection device in accordance with an embodiment of the present disclosure;

FIG. 5 is a flow chart of a method for rapidly collecting greenhouse gas from farmland in batches in accordance with the present disclosure;

In the drawings:
1—motor assembly, 2—fixing post, 3—display screen, 4—thermometer, 5—gas collection device, 6—liquid sealing device, 7—fan, 8—chamber body, 9—base, 10—upright rubber tube, 11—liquid, 12—control apparatus, 13—gas bag box, 14—vacuum gas pump, 15—camera device, 16—exhaust pipe, 17—gas chamber, 18—gas inlet pipe.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a system and a method for rapidly collecting greenhouse gas from farmland in batches, thus satisfying the requirements of collecting greenhouse gases from the farmland rapidly and conveniently under different farmland environments.

To make the above objectives, features and advantages of the present disclosure more apparently and understandably, the present disclosure is further described in detail below with reference to the accompanying drawings and specific embodiments.

A system for rapidly collecting greenhouse gas from farmland in batches includes a static chamber, a static chamber placement device, a gas collection device and a control device.

The static chamber is arranged inside the static chamber placement device, and each static chamber is sleeved outside crops. The gas collection device is arranged in the static chamber placement device. The static chamber, the static chamber placement device and the gas collection device are all in wireless connection with the control device.

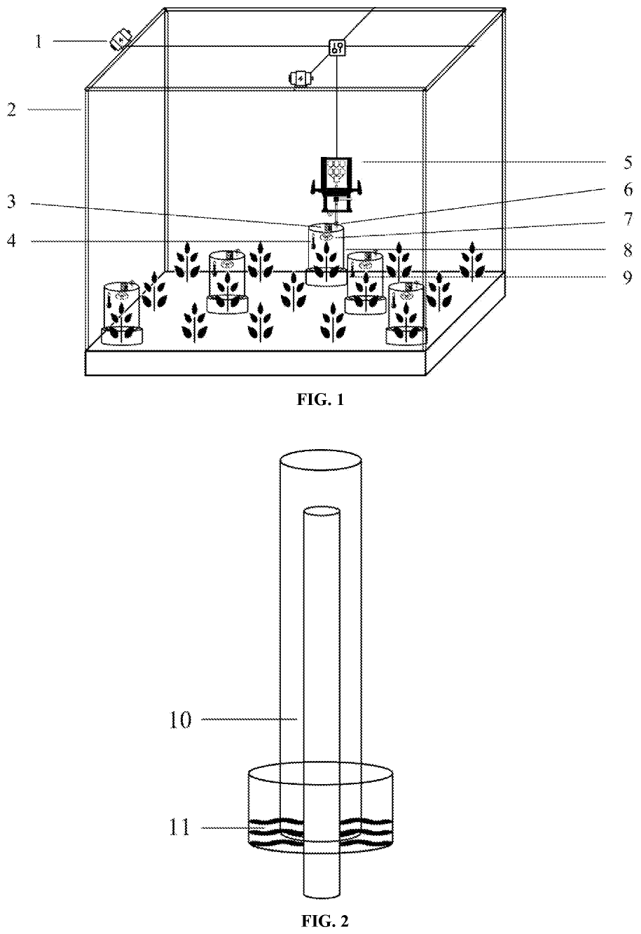

As shown in FIG. 1 and FIG. 2, the static chamber includes a chamber body 8, a base 9, a thermometer 4, a fan 7, a liquid sealing device 6, and a display screen 3.

The chamber body 8 is of a cylindrical structure with a sealed top, and the base 9 is also of a cylindrical structure. The chamber body 8 is provided with four hooks, so as to be mounted by the static chamber placement device.

The thermometer 4, the fan 7, the liquid sealing device 6 and the display screen 3 are all fixed to the chamber body 8, and then the chamber body cooperates with the base 9 to form a gas collection airtight space. A reading of the thermometer 4 and a status of the fan 7 are displayed on the display screen 3. Specifically, the status of the fan 7 and the reading of the thermometer 4 are transmitted to an Internet of Things processor to be processed and then displayed on the display screen 3 above the chamber body 8.

The liquid sealing device 6 is composed of liquid 11, an upright rubber tube 10, and a gas inlet pipe 18. An upper part of the chamber body 8 is provided with an extraction hole, the upright rubber tube 10 is arranged at the extraction hole, and the liquid sealing device 6 is arranged at an interface of the upright rubber tube 10 to guarantee that no air enters.

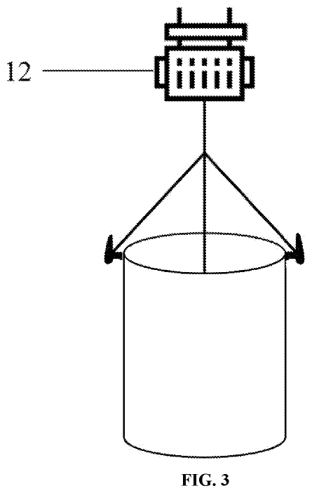

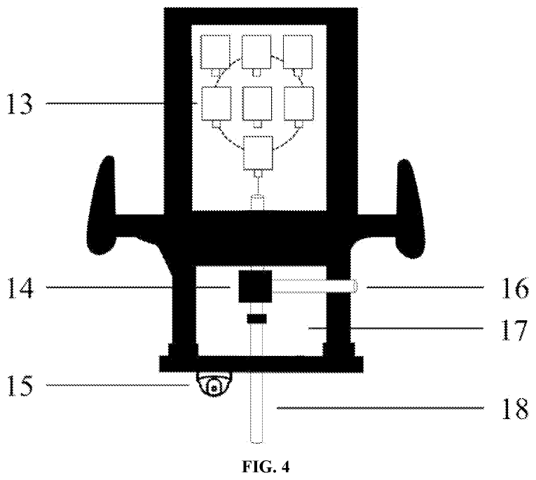

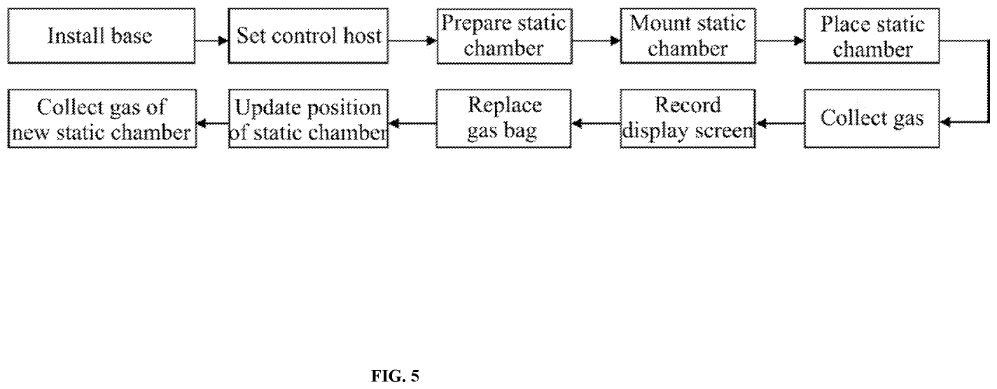

The static chamber placement device is mainly composed of a control apparatus 12. After the control apparatus 12 is connected to the hooks on the chamber body 8, the static chamber can be placed at a corresponding position. For example, as shown in FIG. 1 and FIG. 3, the static chamber placement device includes fixing posts 2, a control apparatus 12, and a motor assembly 1. The fixing posts 2 are placed at four corners for supporting the motor assembly 1 to move the control apparatus 12 in the air. The control apparatus 12 includes a control host which is provided with data processing, storage and transmission elements and can be used to set a static chamber mounting task and a gas collection task. The motor assembly 1 includes a driving motor and an adjusting shaft, such that the static chamber can be placed after the static chamber is mounted on the motor assembly 1 and moved to a designated position. The static chamber is mounted on the motor assembly 1, and then is placed on a base 9 at a corresponding designated position by the motor assembly 1, as shown in FIG. 3. 1. The control apparatus 12 of the static chamber placement device is operated, and a hook of the static chamber placement device is lowered using the motor assembly 1. 2. The static chamber is mounted on the hook of the static chamber placement device. 3. The control apparatus 12 of the static chamber placement device is used to move the static chamber to a designated position using the motor assembly 1, and then the static chamber is lowered. 4. The hook falls off automatically. The control apparatus 12 can be positioned at any position within the range of the fixing posts 2, FIG. 1 shows a result of the static chamber that has been placed. 1. The control apparatus 12 of the static chamber placement device is operated, and a position of the base 9 of the static chamber is manually set. 2. After a task is started, the control apparatus 12 of the static chamber placement device is used to mount the static chambers in sequence and then place each static chamber at a corresponding position.

The gas collection device 5 includes a gas bag box 13, a vacuum gas pump 14, a camera device 15 (i.e., a camera and a host), an exhaust pipe 16, a gas chamber 17, and a gas inlet pipe 18. The gas bag box 13 can hold a certain number of gas bags and replacement gas bags. The vacuum gas pump 14 can extract the gas in the chamber body 8 out through the gas inlet pipe 18, can exhaust the gas from the gas chamber 17 through the exhaust hole 16, and can vacuumize the gas bag in the gas bag box 13 and inject the gas from the gas chamber 17 into the gas bag. The camera device 15 is provided with a camera and a host, the host includes image data processing, storage and transmission elements. The vacuum gas pump 14 can achieve a gas pumping or vacuumizing function, so as to achieve gas transfer. The gas chamber 17 has a gas inlet, an exhaust port, and a gas bag opening. The vacuum gas pump 14 is used to transfer gas or exhaust air through different openings.

A method for rapidly collecting greenhouse gas from farmland in batches includes the following steps.
(1) A base 9 is installed in advance, and a specific position of the base 9 can be set according to actual demands in a control host of a static chamber placement device.
(2) A required static chamber is prepared before collecting, and the fan 7 and the thermometer 4 in the chamber body 8 are turned on.
(3) All static chambers are mounted using the static chamber placement device and placed to corresponding bases 9. In this step, it is also necessary to determine the total time for placing the static chamber. The specific determination method is as follows:
(1) A task load is input into the system, and the system gives a task time range [T_{f}, Tₑ] according to apparatus performance and the task load. A task duration T (T_{f}<T<T_{c}) can be modified by adjusting task parameters of the control apparatus 12, mainly including the total time Tₛ of a static chamber placement stage and the total time T_{c} of a gas collection stage,

$$T = {T}_{S} + {T}_{C}$$

After an operation duration Tis set, the system adaptively calculates and adjusts relevant operating parameters of the static chamber placement device and the gas collection device 5, such as an adjustment parameter μ (0, 1) of placement speed v of the static chamber placement device and an adjustment parameter δ (0, 1) of an injection flow rate qᵥ of the vacuum gas pump 14.

In the implementation process, the range given by the system after calculation can be set after the static chamber placement task and the gas collection task. After specific time is set by a user, the system continuously calculates the duration of each link in reverse and automatically adjusts operating parameters in the process, thus making the total time equal to the time set by the user.
(2) All static chambers are efficiently mounted to the corresponding bases 9 in batches. Assuming that the average mounting time is tₘ, Ci is the i-th static chamber, and the number of all static chambers is Nₛ, then i ∈{1, 2, . . . , Nₛ}. As only one static chamber can be placed every time, the placement speed v follows the variable speed motion. The length, width and height of the system are set to be x, y and z, respectively, the static chamber is lift by h (h<z) meters during the placement process, and a placement position of the i-th static chamber is {(a, b), where a<x, b<y}. As the static chamber moves towards the placement position when lifting, the total distance (the distance of placement and the distance of returning to a starting point after placement) can be recorded as dᵢ:

$${d}_{i} = h + \sqrt{{a}^{2} + {b}^{2} + {h}^{2}} + \sqrt{{a}^{2} + {b}^{2}}$$

Then the time required is as follows:

$${t}_{i} = \frac{{d}_{i}}{v} , i ∈ \{ 1 , 2 , … , {N}_{s} \} , in which v = \frac{μ sin ( x - \frac{π}{2} ) + 1}{2}$$

The total time of the static chamber placement stage is as follows:

$${T}_{S} = {\sum }_{i = 1}^{{N}_{s}} ( {t}_{m} + {t}_{i} )$$

(4) In the gas collection stage, the gas collection device 5 is used to collect gas and record the contents of the display screen 3. In the collection stage, the gas bag is replaced and the position of the static chamber is updated to achieve rapid collection of multiple static chambers in batches. In this process, it is necessary to determine the total time of the gas collection stage, and the specific determination process is as follows:

In the gas collection stage, the gas collection device 5 is used to collect gas and record the contents of the display screen 3. Assuming that a space of the gas chamber 17 is S, the total number of gas bags is Na, the volume of the gas bag is V, an internal pressure is p and a single-side area is Sc in the gas collection device 5. The gas in the gas chamber 17 is exhausted by a vacuum pump 14, and the gas chamber is pumped into vacuum. In this process, the air tightness of the gas chamber 17 is self-inspected, assuming that pumping speed of a previous pump k, an initial air pressure of the gas chamber 17 is p₀, and the final air pressure of the gas chamber 17 is p₁, and the an air tightness leakage rate θ is calculated.

$$θ = ( 1 - \frac{{p}_{1} {t}_{f}}{{p}_{0} {t}_{e}} ) \times 100 \%$$

t_{f} is an absolute temperature (K) of the gas in the gas chamber 17 at the start of the self-inspection, and tₑ is an absolute temperature (K) of the gas in the gas chamber 17 at the end of the self-inspection. If θ<0.2%, the air tightness of the gas chamber 17 is qualified, and evacuation time t_{f} can be calculated:

$${t}_{f} = ( 1 - θ ) \frac{s}{k} ln \frac{{p}_{0}}{{p}_{1}}$$

An injection flow rate of the vacuum gas pump 14 is qᵥ, the cross-sectional area of a gas pipe for injecting gas into the gas bag is A, an average flow rate in the pipe is u, the intensity of pressure detected by the pressure outside the gas bag is pₒ, and a threshold value is Fc.

The extraction time of a corresponding gas chamber 17 of single static chamber is as follows:

$${t}_{e} = \frac{S}{δ {q}_{v}}$$

Gas injection time of a single gas bag is as follows:

$$t = \frac{p \cdot V}{{q}_{v}} = \frac{u \cdot A}{{q}_{v}} ( Stop when {F}_{c} = {p}_{0} \cdot {S}_{c} )$$

The total time of the static chamber placement stage is as follows:

$${T}_{C} = {t}_{f} + {t}_{e} \cdot {N}_{s} + t \cdot {N}_{a} ( p \cdot V \cdot {N}_{a} < S should be satisfied )$$

(5) After the collection at the current gas bag is completed, the collection is conducted after replacing the gas bag and updating the position of the next static chamber until all collections are completed.

Based on the above description, the upright rubber tube of the chamber body of the static chamber is positioned through a computer vision technology, so as to achieve the butt joint of the gas inlet pipe and the upright rubber tube in the liquid sealing device. Real-time images obtained by the camera and the host are processed by the host, so as to identify the upright rubber tube of the chamber body of the static chamber, and then the gas inlet pipe connected to the vacuum gas pump is connected to the rubber tube in the liquid sealing device for gas collection. After the operation of the static chamber is completed, the camera is used to capture the display screen above the static chamber to record a real-time temperature and a fan status. The method not only can work directly in the field, but also simplifies the complex instrument operation. Due to the adoption of mechanical devices, Internet of Things and computer vision technology, the gas collection time is rapid, and the collection efficiency can be effectively improved.

Embodiments in this specification are described in a progressive manner, each embodiment focuses on differences from other embodiments, and the same and similar parts between the embodiments can be referred to each other.

Several examples are used for illustration of the principles and implementation methods of the present disclosure. The description of the embodiments is merely used to help illustrate the method and its core principles of the present disclosure. In addition, those of ordinary skill in the art can make various modifications in terms of specific embodiments and scope of application in accordance with the teachings of the present disclosure. In conclusion, the content of this specification shall not be construed as a limitation to the present disclosure.

What is claimed is:

1. A system for rapidly collecting greenhouse gas from farmland in batches, comprising a static chamber, a static chamber placement device, a gas collection device, and a control device;
the static chamber is arranged inside the static chamber placement device, and each static chamber is sleeved outside crops; the gas collection device is arranged in the static chamber placement device, the static chamber, the static chamber placement device and the gas collection device are all in wireless connection with the control device.

2. The system for rapidly collecting greenhouse gas from farmland in batches according to claim 1, wherein the static chamber comprises a chamber body, a base, a thermometer, a fan, a liquid sealing device, an upright rubber tube, and a display screen;
the chamber body is buckled on the base; the thermometer and the fan are arranged inside the chamber body; the thermometer and the fan are both in wireless connection with the control device;
the chamber body is provided with an extraction hole; the upright rubber tube is arranged at a position corresponding to the extraction hole; the liquid sealing device is arranged at an interface of the upright rubber tube; the chamber body is provided with four hooks, so as to be mounted by the static chamber placement device; the display screen is arranged on the chamber body; and the display screen is in wireless connection with the control device.

3. The system for rapidly collecting greenhouse gas from farmland in batches according to claim 1, wherein the static chamber placement device comprises a plurality of fixing posts, a motor assembly, and a traction device;
a space frame is formed by the plurality of fixing posts; the traction device is arranged at a top end of the space frame, the motor assembly is arranged on the traction device, the traction device is used for mounting the gas collection device or the static chamber; and the motor assembly is in wireless connection with the control device.

4. The system for rapidly collecting greenhouse gas from farmland in batches according to claim 1, wherein the gas collection device comprises a camera device, a vacuum gas pump, a gas inlet pipe, a gas bag box, an exhaust pipe, and a gas chamber;
the camera device is arranged on the gas chamber; the gas inlet pipe passes through the gas chamber and then extends into the gas bag box; the vacuum gas pump is arranged inside the gas chamber; one end of the exhaust pipe is inserted into the gas chamber, and both the exhaust pipe and the gas inlet pipe are connected to the vacuum gas pump.

5. The system for rapidly collecting greenhouse gas from farmland in batches according to claim 1, wherein the control device comprises an Internet of Things processor, and a control apparatus;
the Internet of Things processor is used for generating control data of an electrical signal in the static chamber; and
the control apparatus is used for generating control data of an electrical signal in the static chamber placement device.

6. A method for rapidly collecting greenhouse gas from farmland in batches, comprising the following steps:
obtaining a gas collection task load;
determining a task duration based on the gas collection task load;
determining operating parameters of components in a system for rapidly collecting greenhouse gas from farmland in batches based on the task duration, wherein the system for rapidly collecting greenhouse gas from farmland in batches is the system according to claim 1, and the operating parameters comprise: placement speed of a static chamber placement device and an injection flow rate of a vacuum gas pump; and
respectively determining the total time of a static chamber placement stage and the total time of a gas collection stage based on the operating parameters.

7. The method for rapidly collecting greenhouse gas from farmland in batches according to claim 6, wherein the static chamber comprises a chamber body, a base, a thermometer, a fan, a liquid sealing device, an upright rubber tube, and a display screen;
the chamber body is buckled on the base; the thermometer and the fan are arranged inside the chamber body; the thermometer and the fan are both in wireless connection with the control device; the chamber body is provided with an extraction hole; the upright rubber tube is arranged at a position corresponding to the extraction hole; the liquid sealing device is arranged at an interface of the upright rubber tube; the chamber body is provided with four hooks, so as to be mounted by the static chamber placement device; the display screen is arranged on the chamber body; and the display screen is in wireless connection with the control device.

8. The method for rapidly collecting greenhouse gas from farmland in batches according to claim 6, wherein the static chamber placement device comprises a plurality of fixing posts, a motor assembly, and a traction device;
a space frame is formed by the plurality of fixing posts; the traction device is arranged at a top end of the space frame, the motor assembly is arranged on the traction device, the traction device is used for mounting the gas collection device or the static chamber; and the motor assembly is in wireless connection with the control device.

9. The method for rapidly collecting greenhouse gas from farmland in batches according to claim 6, wherein the gas collection device comprises a camera device, a vacuum gas pump, a gas inlet pipe, a gas bag box, an exhaust pipe, and a gas chamber;
the camera device is arranged on the gas chamber; the gas inlet pipe passes through the gas chamber and then extends into the gas bag box; the vacuum gas pump is arranged inside the gas chamber; one end of the exhaust pipe is inserted into the gas chamber, and both the exhaust pipe and the gas inlet pipe are connected to the vacuum gas pump.

10. The method for rapidly collecting greenhouse gas from farmland in batches according to claim 6, wherein the control device comprises an Internet of Things processor, and a control apparatus;
the Internet of Things processor is used for generating control data of an electrical signal in the static chamber; and
the control apparatus is used for generating control data of an electrical signal in the static chamber placement device.

11. The method for rapidly collecting greenhouse gas from farmland in batches according to claim 6, wherein determining the total time of the static chamber placement stage based on the operating parameters comprises the following steps:
determining a placement path of a static chamber according to a placement position of the static chamber and a lifting distance of the placed static chamber;
setting placement time based on the placement path and placement speed of the static chamber; and
determining the total time of the static chamber placement stage based on the placement time.

12. The method for rapidly collecting greenhouse gas from farmland in batches according to claim 7, wherein determining the total time of the static chamber placement stage based on the operating parameters comprises the following steps:
determining a placement path of a static chamber according to a placement position of the static chamber and a lifting distance of the placed static chamber;
setting placement time based on the placement path and placement speed of the static chamber; and
determining the total time of the static chamber placement stage based on the placement time.

13. The method for rapidly collecting greenhouse gas from farmland in batches according to claim 8, wherein determining the total time of the static chamber placement stage based on the operating parameters comprises the following steps:
determining a placement path of a static chamber according to a placement position of the static chamber and a lifting distance of the placed static chamber;
setting placement time based on the placement path and placement speed of the static chamber; and
determining the total time of the static chamber placement stage based on the placement time.

14. The method for rapidly collecting greenhouse gas from farmland in batches according to claim 9, wherein determining the total time of the static chamber placement stage based on the operating parameters comprises the following steps:
determining a placement path of a static chamber according to a placement position of the static chamber and a lifting distance of the placed static chamber;
setting placement time based on the placement path and placement speed of the static chamber; and
determining the total time of the static chamber placement stage based on the placement time.

15. The method for rapidly collecting greenhouse gas from farmland in batches according to claim 10, wherein determining the total time of the static chamber placement stage based on the operating parameters comprises the following steps:
determining a placement path of a static chamber according to a placement position of the static chamber and a lifting distance of the placed static chamber;
setting placement time based on the placement path and placement speed of the static chamber; and
determining the total time of the static chamber placement stage based on the placement time.

16. The method for rapidly collecting greenhouse gas from farmland in batches according to claim 6, wherein determining the total time of the gas collection stage based on the operating parameters comprises the following steps:
determining an air tightness leakage rate of a gas chamber;
determining evacuation time of the gas chamber based on the air tightness leakage rate;
determining extraction time of the gas chamber of a single static chamber and gas injection time of a single gas bag; and
determining the total time of the gas collection stage according to the evacuation time, the extraction time and the gas injection time.

17. The method for rapidly collecting greenhouse gas from farmland in batches according to claim 7, wherein determining the total time of the gas collection stage based on the operating parameters comprises the following steps:
determining an air tightness leakage rate of a gas chamber;
determining evacuation time of the gas chamber based on the air tightness leakage rate;
determining extraction time of the gas chamber of a single static chamber and gas injection time of a single gas bag; and
determining the total time of the gas collection stage according to the evacuation time, the extraction time and the gas injection time.

18. The method for rapidly collecting greenhouse gas from farmland in batches according to claim 8, wherein determining the total time of the gas collection stage based on the operating parameters comprises the following steps:
determining an air tightness leakage rate of a gas chamber;
determining evacuation time of the gas chamber based on the air tightness leakage rate;
determining extraction time of the gas chamber of a single static chamber and gas injection time of a single gas bag; and
determining the total time of the gas collection stage according to the evacuation time, the extraction time and the gas injection time.

19. The method for rapidly collecting greenhouse gas from farmland in batches according to claim 9, wherein determining the total time of the gas collection stage based on the operating parameters comprises the following steps:
determining an air tightness leakage rate of a gas chamber;
determining evacuation time of the gas chamber based on the air tightness leakage rate;
determining extraction time of the gas chamber of a single static chamber and gas injection time of a single gas bag; and
determining the total time of the gas collection stage according to the evacuation time, the extraction time and the gas injection time.

20. The method for rapidly collecting greenhouse gas from farmland in batches according to claim 10, wherein determining the total time of the gas collection stage based on the operating parameters comprises the following steps:
determining an air tightness leakage rate of a gas chamber;
determining evacuation time of the gas chamber based on the air tightness leakage rate;
determining extraction time of the gas chamber of a single static chamber and gas injection time of a single gas bag; and
determining the total time of the gas collection stage according to the evacuation time, the extraction time and the gas injection time.
